(19) United States
(12) Patent Application Publication
(10) Pub. No.: US 2008/0315772 A1
(43) Pub. Date: Dec. 25, 2008

(54) Method and Apparatus for Lighting Control

(76) Inventor: Engel Johannes Knibbe, Heeze (NL)

Correspondence Address: PHILIPS INTELLECTUAL PROPERTY & STANDARDS, P.O. BOX 3001, BRIARCLIFF MANOR, NY, 10510, US

(21) Appl. No.: 12/097,317

(22) PCT Filed: Dec. 8, 2006
(86) PCT No.: PCT/IB06/54710

§ 371 Date: Jun. 13, 2008

(30) Foreign Application Priority Data
Dec. 19, 2005 (EP) 05112362.8

(51) Int. Cl. H05B 41/36

(52) U.S. Cl. 315/149

(57) ABSTRACT

At least one light source (40) illuminates a room (10) that contains at least one item such as furniture (30). An item sensing device (62, 70) senses the item(s) and determines the location of the item(s) within the room (10). A lighting control system (82) controls the light source(s) in response to the sensed location and movement of the item(s) within the room.

The present invention relates to controlling the lighting system within a room.

It is desirable in homes and other modern buildings to provide an aesthetically pleasing environment through sophisticated lighting systems that provide a wide range of operating characteristics which can be adjusted by the user to suit the needs and desires of the user.

In the coming years, lighting systems are envisaged that provide various desired ambiances in a room or other areas by adjusting lights to the proper intensity, direction, color, etc. depending on the activity/request of the user. For example, a user may want to have a romantic setting, or an action movie setting, or a gaming setting, a chatting setting, or the like. These settings are usually referred to as presets which may be pre-defined by lighting designers (or end-users) and can be used by end-users.

It is desirable to help end-users of lighting systems by providing pre-defined presets for various activities. As these presets are generically defined, without knowing details of the actual environment of the lighting system, lighting designers will make assumptions on where, how many, and what lamps are available and also where room items such as appliances like a TV and audio/visual components are located, for example, as well as where a couch, lounge chairs, artwork, and other furniture are located in a room. Thus, many assumptions are made and a professional lighting designer then defines a fitting preset(s).

When applying such presets in the actual room, a translation is required regarding to what resource, such as light sources, are actually available, as well as the location of such lamps as well as the location of the various room items such as furniture, artworks and multimedia components.

It maybe that the lighting system is able to learn the location of light sources in the room, in the case where the light sources are connectable to the light system, e.g., via RF connectivity such as using protocols that comply with Bluetooth, Zigbee or other connectivity means or standards. In such a system, the location of the light sources can be automatically identified to the system using RF position awareness as is well known in the art. One system for controlling room lighting using transponders and transducers is disclosed in U.S. Pat. No. 6,867,699, which is incorporated herein by reference in its entirety. Another system for lighting control through the Internet is disclosed in U.S. Patent Application Publication No. 2005/0097162, which is incorporated herein by reference in its entirety.

However, for the non-connected elements, such as furniture, artwork, electronic components, etc., there is no simple and automatic way to identify the location of such non-connected elements. The only apparent solution is to manually identify the location to the system via a graphical interface, and manually updating the information when items are moved in the room. Accordingly, there is a need for simple lighting controls that takes into account the location of various items in a room.

In a room that contains various items such as furniture, artwork, and/or electronic components as well as a plurality of light sources, an item (e.g., furniture) sensing device is provided that senses the furniture items and determines the location of the furniture items within the room. A lighting controller controls one or more of the light sources in response to the sensed location and modifies the light sources in response to movement of the furniture items within the room.

To enable the utilization of generic scene descriptions or presets in a specific environment, information needs to be available to the control system about the location of different appliances and furniture relative to where light fixtures are located. The location information may be obtained using the sensors attached to the items in a room, such as RFID tags that identify appliances and furniture. The tagged appliances and furniture can be triangulated, for example, by transceivers to determine the positions of the tagged room items.

Further areas of applicability of the present invention will become apparent from the detailed description provided hereinafter. It should be understood that the detailed description and specific examples, while indicating exemplary embodiments of the invention, are intended for purposes of illustration only and are not intended to limit the scope of the invention. These and other features, aspects, and advantages of the apparatus and methods of the present invention will become better understood from the following description, appended claims, and accompanying drawings where:

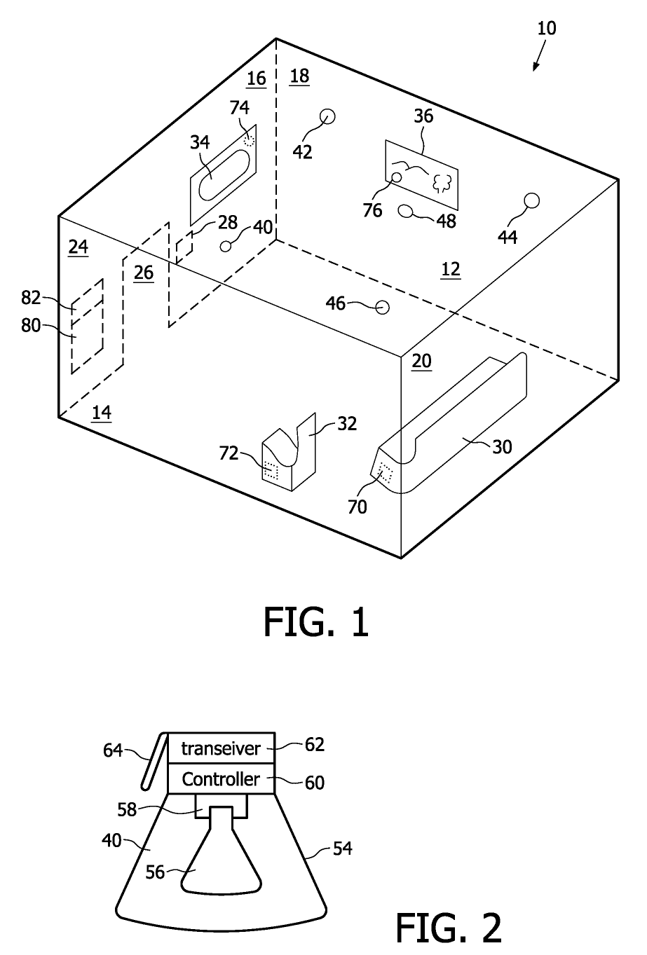

FIG. 1 is a perspective representation of a room in which an embodiment of the invention is installed; and

FIG. 2 is an elevation view of a light fixture with a transceivers and a lamp controller, according to the present invention.

The following description of certain exemplary embodiment(s) is merely exemplary in nature and is in no way intended to limit the invention, its application, or uses.

Referring to FIG. 1, a room 10 in a building is defined by a ceiling 12, floor 14, and walls 16, 18, 20 and 24. The room is entered through a doorway 26. A light switch 28 is mounted on the wall 16 adjacent to the doorway 26, for example.

The room contains various items, such as furniture including a sofa 30, a reading chair 32, a television 34, and an art work 36 that hangs on wall 18. Of course, any other item may also be included in the room, such as various electronic components including a computer, multimedia devices, and the like. The room is illuminated by light fixtures 40, 42, 44, 46 and 48 mounted on the ceiling 12. It should be understood that ceiling mounted light fixtures are used as exemplary light fixtures, where any other type of light fixtures may be used, such as wall mounted fixtures, table top or floor light fixtures and the like.

Referring to FIG. 2, the light fixture 40 includes a housing 54, a lamp 56, socket 58, lamp controller 60, and a transceiver 62 which may include an RFID (radio frequency identification) reader with an antenna 64. Light fixtures 42, 44, 46 and 48 are the same as, or similar to, the light fixture 40. The lamp 56 may be any type of light source, such as incandescent, fluorescent, high intensity discharge (HID), as well as light emitting diodes (LEDs). The lamp controller 60 may be any type of controller, such as a ballast for certain types of lamp as is well know in the art. The lamp controller 60 is configured to control various attributes of the light emitted from the lamp 56, such as intensity, color, hue, saturation and the like, where LEDs are well suited for providing light of different attributes.

Sensors, such as RFID tags, are attached to each or any desired item in the room, including RFID tag 70 attached to the sofa 30, RFID tag 72 attached to the reading chair 32, RFID tag 74 attached to the television 34, and RFID tag 76 attached to the art work 36. The RFID tags may be pre-defined with markings, such as written text or pictograms of a couch, chair, TV etc, so that the end-user simply attaches the tags on the corresponding piece of furniture, art, electronic equipment etc. The tags may also be associated with room items manually, for example, by a user having the tag read by a reader near a user interface 80 or a system controller 82, for example, and inform the system controller 82 that the particular tag is to be attached to a particular room item such as the couch 30, for example. These RFID tags can be activated by the lighting system and then generate their identity to the system.

The RFID tag may be an active tag or a passive tag. In the case of an active tag, the active tag includes a battery and a transceiver for receiving and emitting RF signals. In the case of a passive tag, the passive tag has no battery and, as is well known, the passive tag may extract any needed energy from the received signal and transmit its unique identification in response to the received signal. Of course, the passive tag may also reflect the received signal in such a way that its unique identification may be determined from the reflected signal. The RFID reader 62 may include a transceiver for transmitting and receiving RF signals to and from the RFIDs and the system controller 82. Alternatively, the RFID reader 62 may include only a receiver that reads the signal emitted by the RFID tags, where a transmitter to transmit signals to the RFIDs and the system controller 82 is provided external to the reader 62, such as being part of the lamp controller 60 or separate therefrom. Of course, the RFID reader/transceiver 62 may be part of the lamp controller 60 which receives the information provided by the RFID tags, determines their identity and location, and controls the appropriate right via control signals transmitted to the lamp controller(s) 60, which have receivers for receiving such control signals and associated elements, such as an antenna in the case of wireless transmission.

Illustratively, the user interface panel 80 is mounted on the wall 16 adjacent to the doorway 26. The user interface panel 80 communicates with and includes the system controller 82 or is separate therefrom. The system controller 82 is connected via wires or via a wireless communication link with the lamp controller 60 and the RFID reader 62 of each of the light fixtures 40, 42, 44, 46 and 48. The user interface 80 may be a touch sensitive screen or any type of input/output device for interfacing with the system controller 82, such as a keyboard, mouse, PDA, or a remote control for wirelessly communicating with the system controller 82, for example.

The lamp controller 60 and system controller 82 may include any type of controller, such as a general purpose or dedicated processor, a microprocessor, a central processing unit (CPU) a digital signal processor, application specific integrated circuit (ASIC), as well as portions or combinations of these and other processing devices. As is well known, the lamp and system controllers 60, 82 may communicate with an electronic memory, including RAM, ROM and other types of storage devices, such as disk-based optical or magnetic memory, where program instruction and other data are stored.

In operation, when the lighting system is activated, e.g., by turning on the light switch 28 by a person entering the room 10, the light fixtures 40, 42, 44, 46, and 48 will be energized to light the room 10. Energizing the light fixtures also energizes the RFID transceiver/reader 62 of each of the light fixtures. At least one transmitter or transceiver, e.g., of one of the RFID readers 62, then transmits a message to the RFID tags thus activating them. This process continues until all the tags have been activated by signals from one or more of the readers 62 or the system controller 82. In response, each RFID tag within the room transmits data which is received by all or some of the transceivers of the RFID readers 62 of all or some of the light fixtures and/or the system controller 82. Illustratively, the system controller 82 receives the data (from the RFID tags or readers 62) for processing, such as determining tagged room items locations and controlling the lighting fixtures in accordance with presets and the determined room items locations, for example. The system controller 82 may adjust the presets in accordance with the determined location information indicating the location of the tagged items in the room.

The data received from any of the RFID tags includes a unique identifier for that tag, for example the data emitted by the RFID tag 76 attached to the artwork 36 enables the system controller 82 to segregate and process unique data relative to the art work 36. Additional data, as well as the unique identifier, may be associated with the RFID tags (or may be changed) by the user as desired, e.g., via the user interface 80 and/or the system controller 82 for example, or by the manufacturer of RFID tags, such as particular data associated with particular room items. Illustratively, the RFID tag could be factory delivered/mounted with the artwork, for example. Further, when factory delivered, the tag could contain specific parameters/data relevant for the lighting of the particular associated room item, such as the type, size, color, reflection factor, of the item, as well as suggested lighting parameters, such as type of lamps to use, light spot size, lamp distance from the item, etc. Of course, the system controller 80 may be configured to, such as be provided with algorithms or software to (automatically or manually) obtain or solicit needed information (such as the type and location of lamps and room items) and provide presets or suggestions for presets to be chosen by the user, for example, regarding appropriate lighting conditions in view of the type and location of lamps and room items, for example.

The system controller 82 includes algorithms for processing the unique data of the RFID tags, such as the data for the artwork RFID tag 76, for example. The RFID readers associated with each of the light fixtures 40, 42, 44, 44, and 46 each interrogate and receive data from the artwork RFID tag 76, which data is also provided to the system controller 82. The system controller 82 includes algorithms that calculate the location of each RFID tag, e.g., the artwork RFID tag 76, by triangulating the data (such as the tag ID, signal strength or time of flight of signals) received from each of the RFID readers 62, for example. The location may be determined in two dimensions, or for greater accuracy, in three dimensions. Illustratively, the algorithm can determine locations based on measuring the signal strength and/or the time of flight of the signals transmitted by each RFID tag and received the RFID readers 62 and/or system controller 82. For example, the signal strength is compared with known signal strengths transmitted by the RFID tags. Further, instead of or in addition to triangulation, beam direction can be used, such when only one RFID reader 62 reads the signal strength or time of flight. Additional information regarding the use of RFID technology for determining the location of an RFID tag within a room is disclosed in the published technical report entitled, LANDMARC: Indoor Location Sensing Using Active RFID, by Lionel M. NI, et al., which is incorporated by reference herein in its entirety.

Via the system controller 82 and the user interface 80, the aforedescribed system may be programmed and reprogrammed to enable a wide range of desirable lighting control functions utilizing the lamp types/locations in view of the determined physical locations and types of the items tagged with the RFID tags, e.g., furniture, artwork etc., within the room. Of course, the user may also manually control the light fixtures and program/reprogram the system controller 82.

For example, the light fixture 48 may be a spot light that is focused upon the artwork 36. In the event that the artwork 36 is removed and hung in another room, the removal of the artwork RFID tag 76 from its recognized location may be used as a control input that is processed by the system controller 82, and the system controller 82 may transmit a signal to the lamp controller 60, e.g., a ballast, of the light fixture 48 to extinguish the light fixture 48. The removal of the art work eliminates the need for lighting the art work, and it would not be desirable to illuminate the empty space that remains after the artwork is removed.

As another example, it may be desirable to dim or extinguish the light fixtures 40 and 42 if the sofa is located at the location shown in the FIG. 1 and the television 34 is located beneath the light fixtures 40 and 42. Such a lighting configuration/preset may also be determined and suggested by the system controller 82 in response to choosing a TV watching preset for example. On the other hand, if the television 34 is moved to sit beneath the light fixtures 44 and 46, it may be desirable to either dim or extinguish the light fixtures 44 and 46. Further, when a romantic preset is chosen by the user, the system controller 82 dims particular lights or changes other light attributes, such as color, in accordance with determined tagged room item locations (such as the location of the couch 30) and the romantic setting which may be predetermined/stored or determined by the system controller 82.

The system controller 82 may be programmed to automatically respond by changing the control of the lighting system in response to various changes in the location of the various items tagged with the RFID tags. Or, in some circumstance, it may be desirable to have the system controller 82 go to a default setting, and then issue a visual or audible signal when it is determined that the furniture has been moved, so that the user is informed that he should reprogram the lighting system via the user interface 80, or at least know that the system is about to be automatically reprogrammed. Alternatively or in addition, the user may be prompted by a visual or audible signal to activate the automatic reprogramming or to manually reprogram the system controller 82.

It will be understood that it may be desirable to add additional inputs in the control logic that is managed by the system controller 82. For example, the user interface may have a series of switches by which a user entering the room may select from various lighting scene/preset selections, such as conversation, reading, television viewing, etc. Other presets may also be programmed in the system controller 82, such as presets for a romantic setting, or an action movie setting, or a gaming setting, a chatting setting, or the like. The presets are programmable and may be programmed by the user, or a professional lighting designer. Then, within these preset or scene selections, the sensed location of the tagged items, e.g., furniture, as it may be moved about the room, may be processed by the system controller 82 and used as an input for lighting control, via commands transmitted from the system controller 82 to the various lamp controllers 60 of the various light fixtures to individually or collectively change the light attributes emitted from the light fixtures, such as changing the light intensity, color, hue, saturation, light pattern, time sequential settings where certain lights are sequentially or concurrently turned on, dimmed and/or turned off at timed interval, and the like.

The system controller 82 and user interface 80 may be configured to allow the user to couple the lighting fixtures to room items manually for easier definition of personal presets, which may be suggested by the system controller based on the location information of the tagged items and user information. Of course, the user is also able to define presets and program the system controller 82 in any desired fashion. Further, RFID tags could also be on a person or persons in the room, such as on clothing, thus identifying the person and/or his or her locations and providing relevant data for lighting. For example, from the determined location of the person(s), certain light settings could be deducted and implemented. For example, if a person is detected sitting in a reading chair, e.g., an adult or a household member having a history of reading while sitting in the reading chair during certain times of the day, then a reading light is turned on at the proper light level.

Thus, in the case the RFID tags include data identifying the person(s) or user(s), predetermined lighting data associated with the identified user may be implemented. For example, lighting attributes associated with user A may be turning on a particular light or a set of lights at user pre-defined intensities, which may be dependent on the current location of the user and may be learned from past user actions. Similarly, lighting attributes may be learned, pre-defined, or associated with respect to a group of users. For example, when two or more children are in the room, then the lights are on at substantially full intensity, where most of the light fixtures are turned on. By contrast, when the husband and wife are in the room alone, then only certain lights may be turned on for example at dimmed intensities and/or desired color or light attributes to create a romantic atmosphere, which may also be associated with the time of day, such as when it is late at night.

In addition to dimming, extinguishing, or changing various light attributes of the lamps in the light fixtures using data related to the location of the furniture, it is also desirable to control other attributes and characteristics of the lamps/light fixtures. For example, the light fixtures may be mounted on motorized swivels so that the light fixtures can be rotated and angled to track the movement of a particular person and/or item of furniture. Or, in the case of an LED lighting source, the color, hue and/or saturation of the light may be varied to suit a particular lighting preset or scene selection and furniture and/or person movement.

Instead of manually entering into the system controller 82 data such as the location of furniture or other items in the room, automatic data entry may be performed using (semi) continuous location identification of all relevant elements in a room including persons, where one of the readers 62 interrogates (e.g., transmit a signal to activate) the tags attached to the room items or to clothing of persons for example, in response to which the tags transmit their unique IDs and the plurality of readers 62 determine the location of the room items/persons tagged with the tags. This takes away the manual entry of room items/persons and their locations, and allows the moving of furniture and other relevant items in a room without having to manually re-inform the system where they are located. Instead, the room items locations are automatically determined.

The foregoing description of the invention is merely exemplary in nature and, thus, variations thereof are intended to be within the scope of the invention. For example, the location of room items, e.g., furniture, may be determined by other location sensing technologies as an alternative to the use of RFID technology. Such systems may include any type of sensor capable of receiving a signal and transmitting information, such as the sensor's unique identification. For example, instead of RFID technology, infrared or ultrasonic technology may be used with sensors, transducers and transceivers. The sensing apparatus for these sensing technologies may be conveniently co-located with the light fixtures, or these sensing devices may be located elsewhere in the room, where appropriate, in order to collect data relative to the location of the various room items within the room for transmittal to the system controller 82.

It will be understood and appreciated that the user interface 80 and system controller 82 may be a custom single purpose lighting control panel especially designed for this application, or alternatively, the user interface and system controller 82 may be provided in the form of a personal computer that is programmed as needed to perform the desired lighting control logic. It may not be necessary to have an RFID reader associated with each and every one of the lighting fixtures, so long as sufficient RFID readers are employed to assure that sufficient data is obtained to reliably determine the location of a tagged item of furniture.

Light attribute controls in response to detecting moved items in a room are suited to be carried out by a computer software program running on the system controller 82, for example. Such software can of course be embodied in a computer-readable medium, such as an integrated chip, a peripheral device or memory of the system controller 82 or coupled to the system controller 82, which may include a dedicated processor for performing in accordance with the present invention, or may be a general-purpose processor wherein only one of many functions operates for performing in accordance with the present invention. The processor may operate utilizing a program portion, multiple program segments, or may be a hardware device utilizing a dedicated or multi-purpose integrated circuit. Each of the above systems utilized for identifying the location of tagged room items may be utilized in conjunction with further systems.

Finally, the above-discussion is intended to be merely illustrative of the present invention and should not be construed as limiting the appended claims to any particular embodiment or group of embodiments. Thus, while the present invention has been described in particular detail with reference to specific exemplary embodiments thereof, it should also be appreciated that numerous modifications and changes may be made thereto without departing from the broader and intended spirit and scope of the invention as set forth in the claims that follow. The specification and drawings are accordingly to be regarded in an illustrative manner and are not intended to limit the scope of the appended claims.

In interpreting the appended claims, it should be understood that:
a) the word “comprising” does not exclude the presence of other elements or acts than those listed in a given claim;
b) the word “a” or “an” preceding an element does not exclude the presence of a plurality of such elements;
c) any reference signs in the claims do not limit their scope;
d) several “means” may be represented by the same item or hardware or software implemented structure or function; and
e) each of the disclosed elements may be comprised of hardware portions (e.g., discrete electronic circuitry), software portions (e.g., computer programming), or any combination thereof.

1. A lighting system for a room (10) comprising:
at least one light source (40) for lighting said room(10);
at least one item (30) movably situated within said room (10);
a sensing device (62, 70) configured to determine a location of said at least one item within said room(10); and
a system controller (82) configured to control said at least one light source (40) in accordance with said location.

2. The lighting system of claim 1, wherein said sensing device includes a sensor (70) attached to said at least one item (30) for emitting data unique to said sensor (70), and a plurality of readers (62) situated at various positions within said room configured to determined said location of said at least one item (30).

3. The lighting system of claim 2, wherein said location is determined by at least one of triangulation, measuring strength of a signal from said sensor and received by at least one of said plurality of readers (62), and measuring time of flight of said signal.

4. The lighting system of claim 2, wherein said data includes parameters related to a desired illumination of said at least one item (30).

5. The lighting system of claim 2, wherein said system controller (82) is further configured to includes said data in said sensor (70).

6. The lighting system of claim 1, wherein said sensing device (62, 70) includes at least one of an RFID tag, an ultrasound tag and an infrared tag.

7. The lighting system of claim 1, wherein said system controller (82) is configured to control at least one lighting attribute of said at least one light source (40) in response to said location.

8. The lighting system of claim 7, wherein said at least one lighting attribute includes at least one of a preset, brightness, color, saturation, direction, light pattern and timed settings.

9. The lighting system of claim 1, further comprising a lamp controller (60) configured to change at least one lighting attribute of said at least one light source (40) in response to a signal from said system controller (82).

10. The lighting system of claim 1, wherein said sensing device includes at least one transceiver (62) co-located with said at least one light source (40).

11. The lighting system of claim 1, wherein said system controller (82) is configured to issue at least one of an audible signal and a visual signal when said at least one item (30) is moved.

12. A method for lighting a room (10) having at least one light source (40) and at least one item (30), comprising the acts of:
mounting at least one sensor (70) on said at least one item (30);
mounting a plurality of readers (62) in said room;
calculating a location of said at least one item (30) from a signal emanating from said at least one sensor (70) and received by said plurality of readers (62); and
controlling at least one attribute of said at least one light source (40) in response to said location.

13. The method of claim 12, further comprising the act of configuring said at least one sensor (70) with unique data.

14. The method of claim 12, wherein said at least one sensor (70) is configured to emit unique data in response to a message from one of said plurality of readers (62).

15. The method of claim 12, wherein said at least one sensor (70) includes at least one of an RFID tag, an ultrasound tag and an infrared tag.

16. The method of claim 12, wherein said location is determined by at least one of triangulation, measuring strength of a signal from said at least one sensor (70) and received by at least one of said plurality of readers (62), and time of flight of said signal.

17. The method of claim 12, wherein said at least one attribute includes at least one of a preset, brightness, color, saturation and direction.

18. The method of claim 12, wherein at least one of said plurality of readers (62) includes at least one transceiver co-located with said at least one light source (40).

19. The method of claim 12, further comprising the act of issuing at least one of an audible signal and a visual signal when said at least one item (30) is moved.

20. A computer readable medium having computer readable code embodied thereon, said computer readable code when executed comprising the acts of:
activating at least one sensor (70) located on at least one item (30) in a room (10);
providing a signal from said at least one sensor (70) in response to said activating act;
receiving said signal by a plurality of receivers (62) in said room (10); and
calculating a location of said at least one item (30) from said signal received by said plurality of receivers (62).

21. The computer readable medium of claim 20, further comprising the act of controlling at least one attribute of at least one light source (40) in said room (10) in response to said location.

22. The computer readable medium of claim 20, further comprising the act of issuing at least one of an audible signal and a visual signal when said at least one item (30) is moved.
